(19) United States
(12) Patent Application Publication
(10) Pub. No.: US 2010/0083626 A1
(43) Pub. Date: Apr. 8, 2010

(54) Edging Attachment For Riding Lawn Mowers

(76) Inventor: Douglas Foster, Liberty Township, OH (US)

Correspondence Address: WOOD, HERRON & EVANS, LLP, 2700 CAREW TOWER, 441 VINE STREET, CINCINNATI, OH, 45202, US

(21) Appl. No.: 12/634,389

(22) Filed: Dec. 9, 2009

Related U.S. Application Data
(63) Continuation of application No. 11/275,616, filed on Jan. 19, 2006, now abandoned.

(51) Int. Cl. A01D 34/00

(52) U.S. Cl. 56/12.7; 56/10.1

(57) ABSTRACT

An edging attachment for riding lawn mowers is operable to control the height of an edging blade relative to a ground surface while an operator steers the mower in a desired direction. In one embodiment, the edging attachment is coupled to the mowing deck of a mower and the mowing deck is adjusted using a foot control. The foot control can be manipulated while the operator simultaneously steers the mower using a hand-operable steering controls. Because the edging attachment is coupled to the mowing deck, adjustment of the edging blade height is also effected using the foot control. In another embodiment, a hand-manipulated control is mounted proximate the steering controls to facilitate adjustment of the edging blade while simultaneously steering the mower.

### CROSS-REFERENCE TO RELATED APPLICATIONS

This application is a continuation of, and claims the benefit of priority to U.S. application Ser. No. 11/275,616, filed Jan. 19, 2006 (pending), the disclosure of which is incorporated by reference herein in its entirety.

### FIELD OF THE INVENTION

The present invention relates generally to landscaping devices and methods.

### BACKGROUND OF THE INVENTION

It is common practice to edge the turf around commercial or residential landscape bedding, such as flowerbeds, gardens, and the mulch beds around trees. Typically such edging is created by using simple hand tools. However, the use of hand tools to create edging is time consuming and very labor intensive. To ease the burden of manual labor required to create landscape edging, power driven edging machines have been developed which are specially adapted for creating edging around landscape bedding. Yet, even these power driven edging machines require a significant exertion of effort by users to move and/or guide the machine around the bed.

It is also common practice to use riding mowers to cut the lawns of landscaped areas, particularly when the lawn is large. The operators of such riding mowers often become very skilled at steering the mowers and can operate the mowers within closely defined paths. Accordingly, attachments have been proposed for use with riding mowers and other equipment to facilitate creating edging around landscape bedding. Some of these attachments are fixed in position relative to the frame or structure of the riding mower, and therefore cannot compensate for rocks, tree roots, or other obstructions in the landscape. Other attachments are capable of adjustment, but are generally cumbersome to adjust and require the operator of the mower to stop the machine before adjusting the height as desired. Many such attachments require an operator to dismount the mower to adjust the height of the attachment, resulting in time delays and other inefficiencies.

A need therefore exists for alternative apparatus and methods that can be utilized with riding mowers to create landscape edging, and which can be conveniently adjusted while a user is operating the mower, without requiring the mower to be stopped.

### SUMMARY OF THE INVENTION

The present invention provides an edging attachment for riding lawn mowers to create border edging around landscape bedding. The attachment is operable to adjust the height of an edging blade relative to the ground surface while simultaneously steering the mower along a desired path. Accordingly, mower operators do not need to stop the mower, or dismount the mower to achieve a desired height adjustment of the edging blade. Rather, the height can readily be adjusted during edging to set a desired edging depth and to avoid any obstacles such as rocks, tree roots, etc. that may be in the path of the edging blade.

In one aspect, an edging attachment in accordance with the principles of the invention is mounted to a mowing deck of a riding mower that has a height control for selectively adjusting the height of the mowing deck relative to the ground surface. Operators of the mower can manipulate the height control to adjust the height of the mowing deck and, consequently, the height of the edging blade, while simultaneously manipulating the steering controls to steer the mower in a desired direction. In one embodiment, the height control comprises a foot-operated control that can be manipulated by an operator's foot while simultaneously steering the mower. In another embodiment, the height control is mounted to the steering controls, whereby an operator can selectively control the height of the mowing deck and edging blade while simultaneously steering the mower.

In another aspect of the invention, the edging attachment comprises a support arm coupled to the mowing deck of a mower, and a power-driven edging blade rotatably supported on the support arm. The edging blade is coupled by sheaves and a belt to a mowing blade shaft, whereby the edging blade is caused to rotate when the mowing blade shaft is driven for rotation.

In another aspect of the invention, an edging attachment is movable between a first position wherein an edging blade is engagable with a ground surface to create boundary edging, and a second position where the support arm and edging blade are stowed to a non-use configuration. The second position may be convenient when the mower is not being used for edging, when it is desired to store the mower and edging attachment, or when it is desired to transport the mower and edging attachment to a different location.

These and other features, advantages, and objectives of the invention will become more readily apparent to those of ordinary skill in the art upon review of the following detailed description and accompanying drawings.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the invention in sufficient detail to enable one of ordinary skill in the art to which the invention pertains to make and use the invention.

FIG. 1 is a perspective view depicting an exemplary riding mower, including an exemplary edging attachment in accordance with the principles of the present invention.

FIG. 2 is a side elevation view of the mower and edging attachment of FIG. 1.

FIG. 2A is a side elevation similar to FIG. 2 and depicting an alternative embodiment of a mower and edging attachment.

FIG. 3A is a partial top plan view of the mower and edging attachment of FIG. 1.

FIG. 3B is a partial top plan view, similar to FIG. 3A, depicting the edging attachment in a stowed configuration.

FIG. 4 is a partial cross-sectional view taken along line 4-4 in FIG. 3A.

FIG. 5 is a partial elevation view illustrating selective detail of the edging attachment of FIG. 3B.

### DETAILED DESCRIPTION

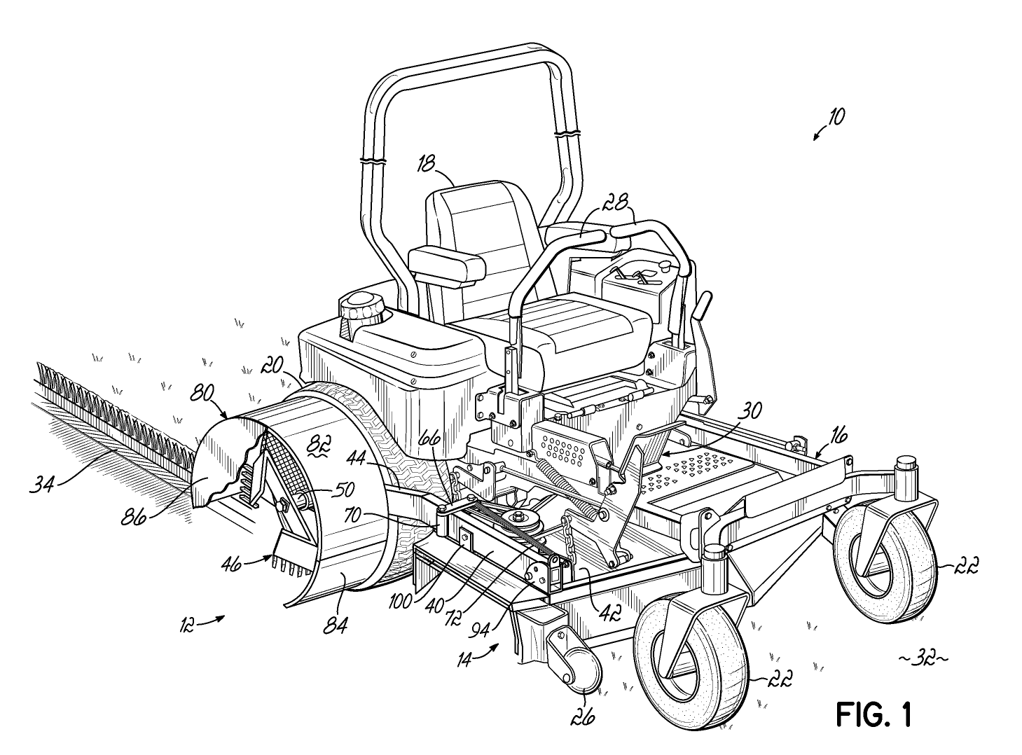

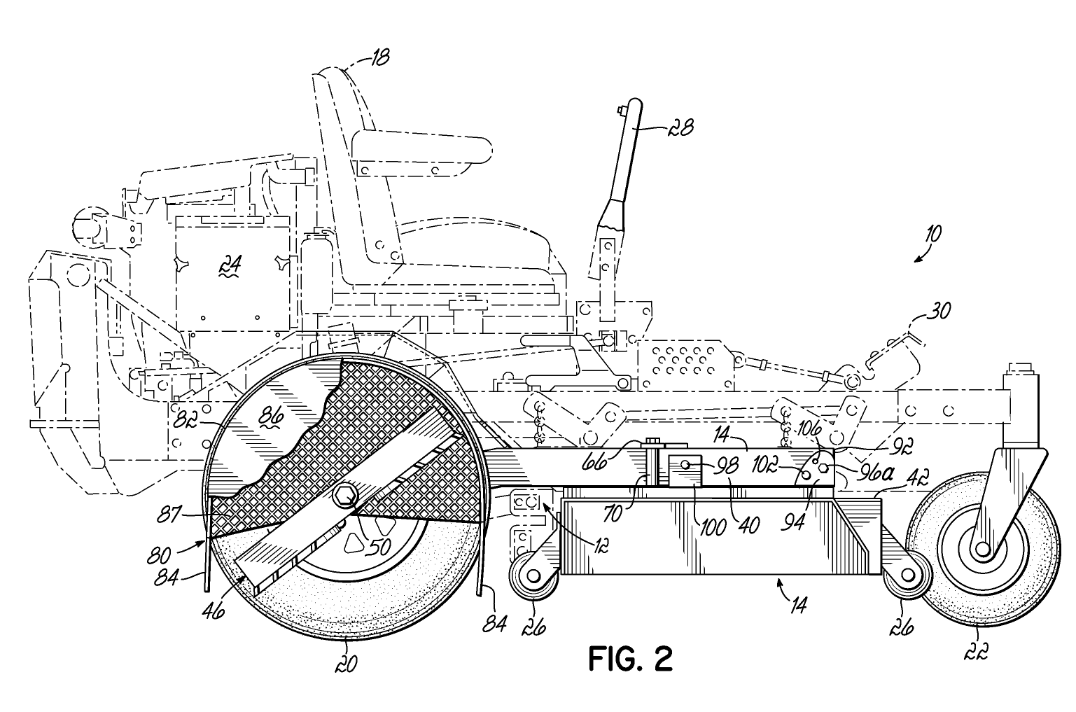

FIGS. 1 and 2 depict an exemplary self-propelled riding lawn mower 10, including an exemplary edging attachment 12 in accordance with the principles of the present invention. In the embodiment shown, the riding mower 10 includes a mowing deck 14 supported on a frame or chassis 16 and housing one or more rotating mowing blades. An operator's seat 18 is supported on the chassis 16, generally above the mowing deck 14. Alternatively, the operator's seat 18 may be located forwardly or rearwardly of the mowing deck 14, or the mower 10 may be configured to pull the operator behind the mower 10, for example, using a sulky, as known in the art. The mower 10 has a plurality of ground engaging wheels, and in the embodiment shown, includes a pair of rear, driven wheels 20 (one shown) and a set of forwardly extending caster wheels 22. Mowing deck wheels 26 may be provided to engage the ground surface at the lowest deck height setting. The rear wheels 20 are propelled by a motor or power plant 24 supported on the chassis 16, and are controlled by steering controls provided proximate the operator's seat 18. In the embodiment shown, the steering controls include first and second steering levers 28 which may be manipulated by the operator to control the forward and/or rearward movement of the rear wheels 20 as desired. Alternatively, the steering controls may comprise a steering wheel, a joystick, or other controls adapted to facilitate steering the mower 10 in a desired direction. The mower 10 depicted in FIGS. 1 and 2 is capable of turning about a fixed point, and is generally referred to as a zero-turn-radius (ZTR) mower. It will be appreciated, however, that the edging attachment 12 described herein may be used with ZTR mowers or various other types of mowers.

With continued reference to FIGS. 1 and 2, the riding mower 10 includes a foot-operated control 30 for selectively adjusting the height of the mowing deck 14 relative to the ground surface 32. Accordingly, the height of the mowing deck 14, and thus the cutting height of the mowing blades may be adjusted by an operator using the foot-operated control 30 while simultaneously manipulating the first and second control levers 28 to steer the mower 10.

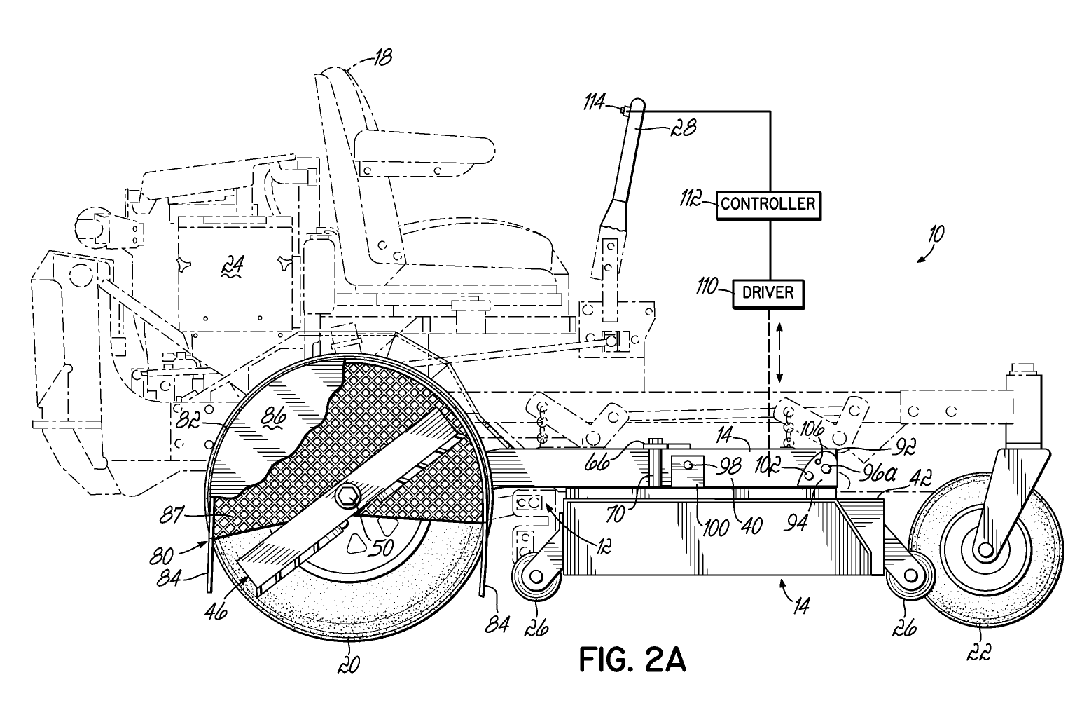

With continued reference to FIGS. 1 and 2, and referring further to FIG. 3A, the mower 10 includes an edging attachment 12, in accordance with the principles of the present invention, secured to the mowing deck 14 for movement therewith when the operator adjusts the height of the mowing deck 14 using the foot-operated control 30. In the embodiment shown, the edging attachment 12 comprises an elongate support arm 40 attached to an upper surface 42 of the mowing deck 14 such that a first end 44 of the support arm 40 extends rearwardly of the mowing deck 14, in a direction toward the rear wheels 20 of the mower 10. The support arm 40 comprises a generally rectangular steel tube which has been secured to the mowing deck 14 using bolts and associated brackets, as will be described more fully below. This bolted connection permits easy installation and removal of the edging attachment 12 from the mowing deck 14. Alternatively, it will be appreciated that the edging attachment 12 may be secured to the mowing deck 14 in various other ways, including permanently fixing the edging attachment 12 to the mowing deck 14, such as by welding.

In the embodiment shown, the first end 44 of the support arm 40 is angled downwardly toward the ground surface 32. An edging blade 46 is rotatably coupled to the first end 44 of the support arm 40 such that the edging blade 46 may be caused to engage the ground surface 32 and thereby turn up the soil as the mowing deck 14 is lowered to an appropriate height and the operator steers the mower 10 in a desired direction. The edging blade 46 is attached to a stub shaft 50 which is in turn supported by a bearing 52 provided on the first end 44 of the support arm 40. The stub shaft 50 extends through the bearing 52, and a first sheave 54 is mounted to the stub shaft 50, opposite the edging blade 46. A belt 56 may be routed through the first sheave 54 and connected to a suitable rotating drive component of the mower 10 to thereby cause the edging blade 46 to rotate. In the embodiment shown, the belt 56 and first sheave 54 are driven by a second sheave 58 which is attached to a mowing blade drive shaft 60. As depicted in FIG. 3A, the second sheave 58 is secured to the generally vertically oriented mowing blade drive shaft 60 and the belt 56 is routed through the first and second sheaves 54, 58. The edging attachment 12 may further include an idler pulley 62 and a tension pulley 64 through which the belt 56 may be routed. In the embodiment shown, the idler pulley 62 is mounted to the mowing deck 14 and the tension pulley 64 is supported on a tension arm 66 that is pivotally attached to the support arm 40, such as by a pin or lag bolt 68 which extends through a tube 70 fixed to the support arm 40, such as by welding. A tension spring 72 secured between the tension arm 66 and the support arm 40 applies a tension force to the tension arm 66 and tension pulley 64 to keep the belt 56 taut. It will be recognized that various other ways of providing and securing a tension pulley 64 to the edging attachment 12 may be utilized, and the invention is not limited in this respect to the embodiment depicted and described herein.

With continued reference to FIGS. 1, 2, and 3A, the mowing blade shaft 60 is generally driven by a drive shaft or power take-off operatively coupled to the power plant 24 of the mower 10. For example, the mowing blade shaft 60 may be driven directly by the mower's power plant 24, such as through a gear train (not shown) or a belt 74 and sheave 76 separate from the belt 56 and sheaves 54, 58 used to drive the edging blade 46. Alternatively, the mowing blade shaft 60 may be driven by a power source separate from the mower's power plant 24.

In one embodiment, the edging attachment 12 further includes a protective cover 80 substantially surrounding the edging blade 46 to thereby reduce the amount of dirt and other debris from being thrown by the rotating edging blade 46. Cover 80 may be secured to the support arm 40, or other structure, and may be removable to facilitate service, storage, and/or transportation of the mower 10. In the embodiment shown, the protective cover 80 comprises a generally arcuate shroud 82 positioned generally over the edging blade 46 and extending both forwardly and rearwardly of the edging blade 46. The shroud 82 may be formed from solid or perforated sheet metal material, or may be formed from various other materials suitable for containing dirt and debris which may be loosened and thrown by the edging blade 46. Flexible flaps or curtains 84 may be provided on the shroud 82, adjacent the forward and rearward edges of the shroud 82, and a lateral flap or curtain 86 may be secured to the outboard side of the shroud 82, opposite the rear wheel of the mower 10, to thereby contain the loosened dirt and debris while also accommodating adjustment of the height of the mowing deck 14 and edging attachment 12 relative to the ground surface 32. The inboard side of the shroud 83 may also be covered with a curtain or other material to help contain loosened debris. In the embodiment shown, the inboard side of the shroud 82 is covered with a perforated screen 87.

As shown in FIG. 3A, the stub shaft 50 of the exemplary edging attachment 12 is positioned adjacent the axis 88 of the rear, driven wheels 20. When the rear, driven wheels 20 are controllable for independent forward and backward movement to steer the mower, this configuration provides maximum maneuverability of the edging attachment 12 and allows an operator to easily view an intended path for edging the ground surface 32, and to observe the edging 34 that was created in the ground surface 32.

Edging attachment 12 may be used with a riding mower 10 to create boundary edging 34 along landscape bedding. In one embodiment, the edging attachment 12 is utilized when the mower 10 is not being used to cut grass, such as at the beginning of the landscape season. In this embodiment, the operator may remove the mowing blades when using the edging attachment 12. In another embodiment, the edging attachment 12 is used in conjunction with, or in addition to use of the mowing blades to cut a lawn.

In use, an operator has the mower 10 running and adjusts the deck height to set the edging blade 46 to cut a desired depth into the ground surface 32. Mowing blade shaft 60 is actuated to drive the belt 56 and first and second sheaves 54, 58, thereby causing the edging blade 46 to rotate. The operator then manipulates the steering controls 28 to drive the mower 10 and move the edging blade 46 along the desired path. If the operator desires to raise the edging blade 46, the foot-actuated control 30 may be manipulated by the operator to raise the mowing deck 14 while simultaneously manipulating the steering controls 28 to drive the mower 10. Because the support arm 40 of the edging attachment 12 is secured to the mowing deck 14 for movement therewith, the height of the edging blade 46 relative to the ground surface 32 is also adjusted. This may be desired, for example, when the operator sees or otherwise senses that the edging blade 46 will engage, or has engaged an obstruction, such as a stone or tree root in the path of the edging blade 46. Because the foot-operated control 30 can be used to raise and lower the edging blade 46 relative to the ground surface 32 while the operator continues to manipulate the steering controls 28 and drive the mower 10, the edging attachment 12 of the present invention reduces the time to edge a landscaped area. The operator does not have to discontinue the edging task or stop the mower 10 to adjust the height of the edging blade 46. Moreover, because many operators become very proficient at steering the riding mower along a desired path, an edging attachment 12 in accordance with the principles of the present invention provides a convenient way to easily edge a landscaped area utilizing a machine with which the operator is intimately familiar.

In one embodiment, therefore, a method of edging a ground surface 32 using an edging attachment 12 of a riding mower 10 includes positioning an edging blade 46 at a desired location for edging the ground surface 32, providing power to the edging blade 46 to cause it to rotate, and adjusting a height of the edging blade 46 relative to the ground surface 32 while manipulating the steering controls 28 of the riding mower 10. In one embodiment, adjusting the height of the edging blade 46 relative to the ground surface 32 includes using a foot-operated control 30 to selectively adjust the height of a mowing deck 14 and an edging blade 46 coupled to the mowing deck 14 for movement therewith.

While the riding mower 10 described above utilizes a foot-operated control 30 to allow an operator to raise and lower the mowing deck 14, and therefore adjust the height of an edging blade 46 coupled to the mowing deck 14, while simultaneously manipulating the steering controls 28 of the riding mower 10, it will be appreciated that the height of the mowing deck 14 may alternatively be adjusted by various other mechanisms and methods while still allowing the operator to manipulate the steering controls 28. Referring to FIG. 2A, for example, riding mower 10 may alternatively be provided with a driver 110, such as a motor, or a hydraulic or pneumatic cylinder, for adjusting the height of the mowing deck 14 and which is controlled by a controller 112 and actuated by a hand-manipulated control 114 mounted to the steering controls 28, such that an operator of the mower 10 can actuate the hand-manipulated control 114 while simultaneously manipulating the steering controls 28 to steer the mower 10. This hand-manipulated control may include a button or toggle switch mounted, for example, to one or both of the steering levers 28 of the mower 10. It will be recognized that various other hand-manipulated controls may be used to raise and/or lower the mowing deck 14 and edging attachment 12.

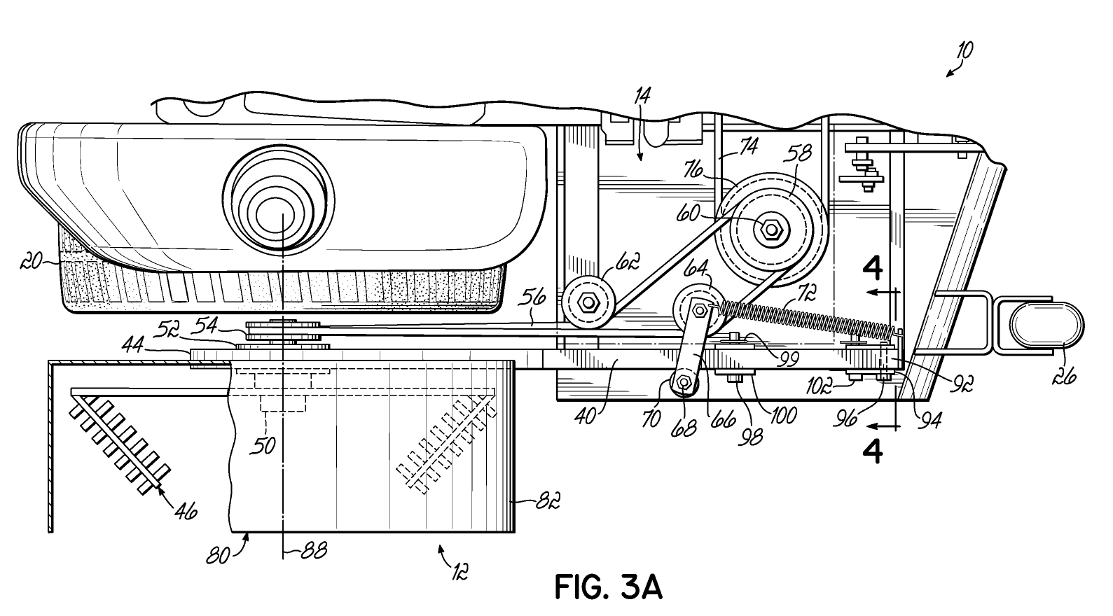

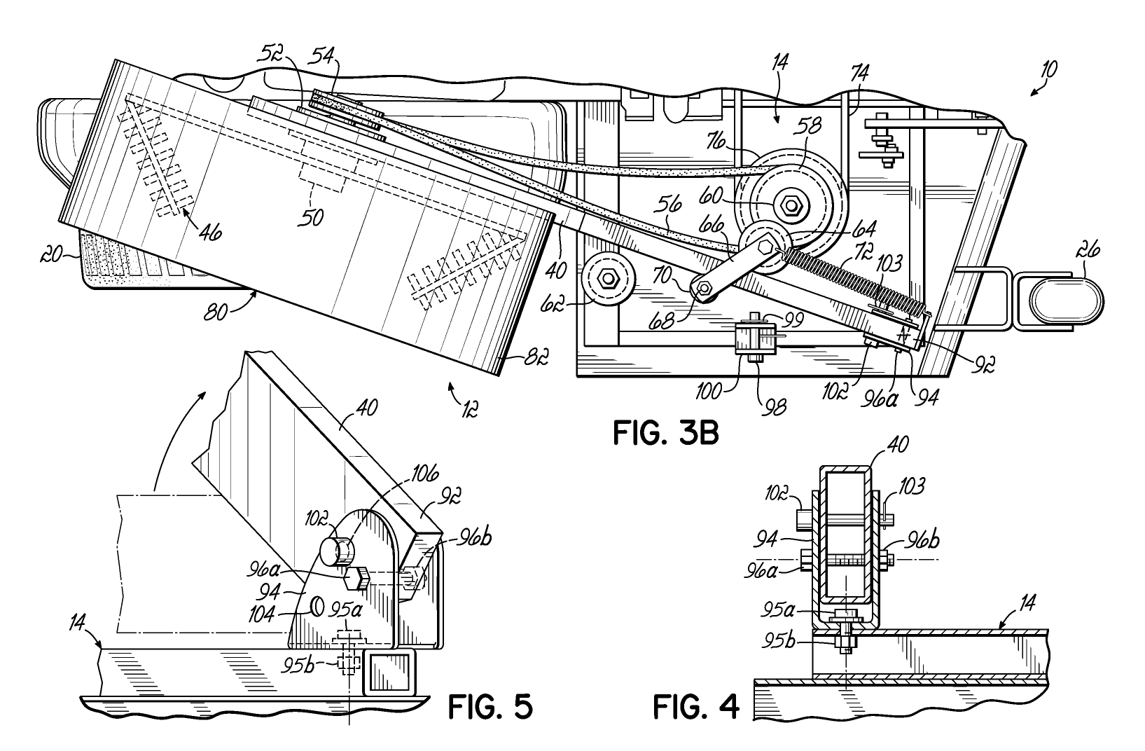

In another embodiment, the edging attachment 12 is mounted to the mowing deck 14 such that the support arm 40 may be selectively moveable to a first position, depicted in FIGS. 1, 2 and 3A, wherein the support arm 40 and the edging blade 46 may be operated as described above to edge a ground surface 32. The support arm 40 may be selectively moved to a second position, depicted in FIG. 3B, wherein the support arm 40 and edging blade 46 are displaced from the ground surface 32 to a stowed position, such as a position generally above the mowing deck 14. This second, stowed position may be used, for example, when the edging blade 46 is not needed to edge the ground surface 32, or when it is desired to store the mower 10 in a shed or other building, or when it is desired to place the mower 10 on a trailer so that it can be transported to a different location, etc. In the embodiment shown, particularly with reference to FIGS. 4 and 5, a second end 92 of the support arm 40 is pivotally secured to a clevis bracket 94 by a lag bolt 96a and a corresponding nut 96b such that the support arm 40 can be pivoted in an upward direction about the second end 92. The clevis bracket 94 is swivelly mounted to the mowing deck 14, for example, by lag bolt 95a and nut 95b, such that the support arm 40 may also be swung to a position inboard of the outer edge of the mowing deck 14.

When the edging attachment 46 is being used to edge a landscaped area, the support arm 40 is in the first position described above. The support arm 40 may be secured in this position, for example, by clamping hardware such as a lag bolt 98 or other fasteners mounted through the support arm 40 and coupled to a clamping bracket 100 fixed to mowing deck 14. Lag bolt 98 may be retained on bracket 100, for example, with a hair-pin clip 99 or other suitable hardware. A movable locking pin 102 may also be provided on the clevis bracket 94 to help retain the support arm 40 in the first position. The locking pin 102 is inserted through a first set of holes 104 on the clevis bracket 94 and corresponding holes (not shown) formed through the support arm 40, which holes are aligned when the support arm 40 is in the first position. Locking pin 102 may be retained with a hair-pin clip 103 or other hardware suitable for securing pin 102 in position, as known in the art.

When it is desired to move the support arm 40 and edging blade 46 from the first position to the second, stowed position, the belt 56 is lifted off the idler pulley 62 and the clamping hardware and locking pin 102 are removed to allow the support arm 40 to pivot about the second end 92. The support arm 40 is pivoted upwardly to clear the rear wheel 20 and any other structure of the mower 10, and is then swung inwardly to the second position, where the edging attachment 12 is located inboard from the outer edge of the mowing deck 14. The locking pin 102 may be reinstalled into a second set of holes 106 in the clevis bracket 94 to help retain the edging attachment 12 in the second position. This second, stowed position provides a more compact profile of the mower 10 and edging attachment 12, which may be convenient for storage and/or transportation of the mower 10.

While the present invention has been illustrated by the description of various embodiments thereof, and while the embodiments have been described in considerable detail, the description herein is not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A zero-turn-radius riding mower, comprising:
hand-operable steering controls adapted to facilitate steering the mower;
rear, driven wheels responsive to said hand-operable steering controls;
a mowing deck including at least one shaft for rotatably supporting a mowing blade thereon;
a height control for selectively adjusting a height of said mowing deck relative to a ground surface while operating said steering controls;
a support arm rigidly coupled to said mowing deck for movement therewith during height adjustment relative to the ground surface using said height control; and
a power-driven edging blade rotatably supported on said support arm such that a rotational axis of said edging blade is aligned with a vertical plane containing a rotational axis of said rear, driven wheels, said edging blade movable with said support arm and said mowing deck for height adjustment using said height control and operatively coupled to said mowing deck shaft for rotation of said edging blade.

2. The mower of claim 1, wherein said height control is a foot-operated control.

3. The mower of claim 1, wherein said height control is mounted to said steering controls such that an operator of the mower can actuate said height control while manipulating said steering controls to steer the mower.

4. A method of edging a ground surface using an edging attachment of a zero-turn-radius riding mower, the mower having hand-operated steering controls and rear, driven wheels responsive to the steering controls, the method comprising:
positioning an edging blade such that a rotational axis of the edging blade is aligned with a vertical plane containing a rotational axis of the rear, driven wheels for edging a ground surface;
providing torque to the edging blade from a mowing blade drive shaft to cause the edging blade to rotate;
adjusting a height of the edging blade relative to the ground surface while manipulating the steering controls to steer the mower.

5. The method of claim 4, wherein adjusting the height of the edging blade comprises actuating a foot-operated control.

6. The method of claim 5, wherein the mower has a mowing deck that is height adjustable relative to the ground surface using the foot-operated control and wherein the edging blade is operatively coupled to the mowing deck for movement therewith for adjustment to a selected height using the foot-operated control.

7. The method of claim 4, wherein adjusting the height of the edging blade comprises actuating a height control mounted on the steering controls.

8. The edging attachment of claim 1, further comprising:
a first sheave on said support arm, said first sheave coupled to said edging blade;
a second sheave operatively coupled to the mowing blade shaft; and
a belt in operative engagement with said first and second sheaves, whereby said edging blade is driven by rotation of the mowing blade shaft.

9. The edging attachment of claim 1, configured for attachment to the mower such that said support arm is selectively movable to a first position wherein said support arm and edging blade are operable to edge a ground surface, and a second position wherein said support arm and edging blade are stowed to a non-use configuration.

10. The edging attachment of claim 1, further comprising an enclosure surrounding said edging blade to reduce debris thrown by said edging blade during edging.

11. A method of edging a ground surface using an edging attachment of a zero-turn-radius riding mower, the mower having hand-operated steering controls and rear, driven wheels responsive to the steering controls, the method comprising:
positioning an edging blade such that a rotational axis of the edging blade is aligned with a vertical plane containing a rotational axis of the rear, driven wheels for edging a ground surface;
providing torque to the edging blade to cause the edging blade to rotate; and
adjusting a height of the edging blade relative to the ground surface while manipulating the steering controls to steer the mower;
wherein providing torque to the edging blade causes the edging blade to rotate independently of contact with the ground surface.

12. The method of claim 11, wherein adjusting the height of the edging blade comprises actuating a foot-operated control.

13. The method of claim 12, wherein the mower has a mowing deck that is height adjustable relative to the ground surface using the foot-operated control and wherein the edging blade is operatively coupled to the mowing deck for movement therewith for adjustment to a selected height using the foot-operated control.

14. The method of claim 11, wherein adjusting the height of the edging blade comprises actuating a height control mounted on the steering controls.

15. An edging attachment for a riding mower having rear, driven wheels and a mowing deck that is adjustable to different heights relative to the ground surface using a foot-operated control, and having at least one mowing blade shaft for rotatably supporting a mowing blade, the edging attachment comprising:
a support arm couplable to the mowing deck for height adjustment therewith when the mowing deck is adjusted by the foot-operated control; and
an edging blade rotatably supported on said support arm such that a rotational axis of said edging blade is aligned with a vertical plane containing a rotational axis of the rear, driven wheels of the mower;
said edging blade adapted to be operatively coupled to and driven by the mowing blade shaft.
